(19) United States
(12) Patent Application Publication
(10) Pub. No.: US 2025/0209281 A1
(43) Pub. Date: Jun. 26, 2025

(54) ADAPTIVE QUERY ROUTING FOR NATURAL LANGUAGE GENERATORS BASED ON QUERY DIFFICULTY

(71) Applicant: Microsoft Technology Licensing, LLC, Redmond, WA (US)

(72) Inventors: Ankur MALLICK, Bellevue, WA (US); Daniel Eduardo MADRIGAL DIAZ, Zapopan (MX); Chi WANG, Redmond, WA (US); Robert Alexander SIM, Bellevue, WA (US); Victor RÜHLE, Cambridge (GB); Ahmed AWADALLAH, Redmond, WA (US); Dujian DING, Richmond, BC (CA)

(73) Assignee: Microsoft Technology Licensing, LLC, Redmond, WA (US)

(21) Appl. No.: 18/393,211

(22) Filed: Dec. 21, 2023

(51) Int. Cl. G06F 40/40; G06F 11/34; G06F 16/33

(52) U.S. Cl. CPC G06F 40/40; G06F 11/3409; G06F 16/3347

(57) ABSTRACT

Natural language generators (NLGs), including large language models, are powerful technologies that are in widespread use. However, typically, as NLGs become more powerful and sophisticated, their correspondingly increased complexity requires substantial processing resources. The present disclosure provides automated techniques for dynamically routing queries between at least two NLGs based on an assessment of query difficulty. Less difficult queries can be routed to a less resource intensive NLG, while more difficult queries are routed to a more sophisticated, but more resource intensive NLG. Routing less difficult queries to a less resource intensive model can thus conserve computing resources, while providing little to no drop in response quality, and in some cases providing improved response quality.

### FIELD

The present disclosure generally relates to processing of queries using natural language generators. Particular implementations provide for selective and dynamic routing of queries between different natural language generators based on an assessed difficulty of a query, where routing less difficult queries to natural language generators with lower computing resource use can provide improved efficiency compared with processing of such queries by a more resource intensive natural language generator.

### BACKGROUND

Generative AI (artificial intelligence), such as that implemented using large language models like CHATGPT from OPEN AI, is experiencing one of the fastest adoption rates in technological history. Beyond its “standalone” applications, such as consumer-facing implementations of CHATGPT, there is a growing interest among companies in integrating generative AI into various software applications, including spreadsheet programs and word processing software.

Certain technologies used for generative AI, such as natural language generators, including large language models (LLMs) and other transformer-based techniques, differ from some other AI processes like neural network classifiers. Generative AI techniques can consume significant computing resources both during training and inference phases, whereas, for neural network classifiers, for example, training is typically resource intensive, but inference is not. This resource demand of generative AI techniques can be attributed, in part, to the exceptionally large number of parameters employed by these models. For example, LLMs can comprise tens to hundreds of billions of parameters.

Consequently, while the increased adoption of generative AI offers substantial practical advantages, it also entails substantial utilization of computational resources. Therefore, there is ample room for improvement in terms of efficiency and resource optimization in the use of generative AI.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Natural language generators (NLGs), including large language models, are powerful technologies that are in widespread use. However, typically, as NLGs become more powerful and sophisticated, their correspondingly increased complexity requires substantial processing resources. The present disclosure provides automated techniques for dynamically routing queries between at least two NLGs based on an assessment of query difficulty. Less difficult queries can be routed to a less resource intensive NLG, while more difficult queries are routed to a more sophisticated, but more resource intensive NLG. Routing less difficult queries to a less resource intensive model can thus conserve computing resources, while providing little to no drop in response quality, and in some cases providing improved response quality.

In one aspect, the present disclosure provides a process of performing adaptive query routing using disclosed techniques. A first query is received. A first set of one or more query difficulty metric values for a set of one or more query difficulty metrics are generated for the first query. It is determined, based on the first set of one or more query difficulty metric values, that the first query is of a first query difficulty level. Based on the determining that the first query is of the first query difficulty level, the first query is routed to a first natural language generator model specified for the first query difficulty level. A second query is received. A second set of one or more query difficulty metric values for the set of one or more query difficulty metrics are generated for a second query. It is determined, based on the second set of one or more query difficulty metric values, that the second query is of a second query difficulty level, the second query difficulty level being different than the first query difficulty level. Based on the determining that the second query is of the second query difficulty level, the second query is routed to a second natural language generator model specified for the second query difficulty level.

In another aspect, the present disclosure provides a process of training a router that can perform adaptive query routing using techniques according to the present disclosure. A router is trained that performs routing of received queries to a determined natural language generator model of a plurality of available natural language generator models. The training includes performing various operations for given queries of a set of training queries.

The operations include generating a vector-space embedding of a given query of the set of training queries. A first response for the given query is generated using a first natural language generator model of the plurality of available natural language generator models. A second response for the given query is generated using a second natural language generator model of the plurality of available natural language generator models.

A quality metric for the first response is calculated. A quality metric for the second response is calculated. A label is assigned to the given query using the quality metric for the first response and the quality metric for the second response. The label indicates a difficulty of the given query. A query difficulty metric value is generated by submitting the vector-space embedding of the given query and the label for the given query to a machine learning model.

The machine learning model is trained to provide a trained machine learning model by minimizing a loss function that uses the label for the given query and the query difficulty metric value for the given query. The router includes the trained machine learning model and selectively routes less difficult queries to the first natural language generator model, saving computing resources compared with processing the less difficult queries using the second natural language generator model.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram illustrating a computing environment supporting adaptive routing of queries to different natural language generators based on query difficulty.

FIG. 2 is a graph illustrating probability distribution function results and associated BART score evaluations of query response quality for two LLM models, demonstrating a quality gap between responses provided by such models.

FIG. 3 provides graphs illustrating, respectively, a distribution of values using unadjusted labels, a grid search to identify an adjustment value, and a distribution of values using labels adjusted with the adjustment value.

FIG. 4 is a diagram illustrating a scenario for scoring query responses using an NLG model.

FIG. 5 is a flowchart of a query routing method according to the present disclosure.

FIG. 6 is a flowchart of a process of training an adaptive query router that routes queries based on query difficulty.

FIG. 7 is a diagram of an example computing system in which some described embodiments can be implemented.

FIG. 8 is an example cloud computing environment that can be used in conjunction with the technologies described herein.

### DETAILED DESCRIPTION

### Example 1—Overview

Generative AI (artificial intelligence), such as that implemented using large language models like CHATGPT from OPEN AI, is experiencing one of the fastest adoption rates in technological history. Beyond its “standalone” applications, such as consumer-facing implementations of CHATGPT, there is a growing interest among companies in integrating generative AI into various software applications, including spreadsheet programs and word processing software.

Certain technologies used for generative AI, such as large language models (LLMs) and other transformer-based techniques, differ from some other AI processes like neural network classifiers. Generative AI techniques can consume significant computing resources both during training and inference phases, whereas, for neural network classifiers, for example, training is typically resource intensive, but inference is not. This resource demand can be attributed, in part, to the exceptionally large number of parameters employed by these models. For example, LLMs can comprise tens to hundreds of billions of parameters.

Consequently, while the increased adoption of generative AI offers substantial practical advantages, it also entails substantial utilization of computational resources. Therefore, there is ample room for improvement in terms of efficiency and resource optimization in the use of generative AI.

The present disclosure provides techniques for dynamically routing queries to different natural language generation (NLG) generative AI models, particularly LLM models. The routing decision is made by analyzing a query to determine at least one metric that describes a difficulty of the query. Query difficulty refers to a measure related to a performance gap between two or more NLG models in generating query responses. In general, the present disclosure related to routing queries between two models, where the models vary in terms of “costs.” Costs can include factors such a response time/latency, energy use, or use of computing resources, such as processors, memory, or network resources.

So, query difficulty can be reflected as a measure of how the response provided by a less resource intensive NLG model compares the response provided by a more resource intensive NLG model. A query can be characterized as lower difficulty if the performance gap in response quality is comparatively low between two NLG models, or characterized as higher difficulty of the performance gap is comparatively high. Typically, less difficult queries are routed to a less resource intensive NLG mode, while more difficult queries are routed to more resource intensive NLG models, which are expected to produce higher quality responses for the query.

Various techniques can be used to determine whether a particular query to be routed is of low or high difficulty. In a specific example, a classifier, such as one based on a neural network, is trained with a set of queries and their associated difficulty metric values. When a query is received, the query can be classified using the classifier, and sent to the appropriate NLG model based on that classification.

Disclosed techniques can thus provide a number of advantages. For queries where a less resource intensive NLG model can provide an acceptable response, routing the queries to such model rather than a more resource intensive model can save significant computing resources, reducing the burden on more complex, resource intensive systems, and making them more available for processing queries where a higher quality response from the more resource intensive NLG model make its use justified. Compared with other types of routing, disclosed techniques can also be beneficial as they can save computing resources without a significant loss of response quality. That is, users do not receive low quality responses just because a less resource intensive NLG model was used, since the queries are “filtered” so that the less resource intensive NLG model will provide a response of acceptable quality.

In fact, in some cases, manually reviewing a query may lead to a conclusion that a particular query is “difficult,” but where in fact a less resource intensive NLG model provides higher quality results than a more resource intensive NLG model. Disclosed techniques, such as through the use of a query classifier, can provided improved query responses for certain queries even as compared with using the more resource intensive NLG model for all queries.

It is noted that disclosed techniques differ from other techniques usable to route queries, including routing of queries based on a “task type.” For example, some techniques may route queries to a particular type of AI model based on a task type, such as routing image generation tasks to one model or various types of NLG tasks (such as summarizing content, creating content, evaluating content, performing mathematical calculations or performing logical tasks, answering factual questions, translating language, generating programming code or scripts) to other models that are more specifically configured for a particular task type. Even for tasks of a common “type,” some queries may still be more “difficult” than others, and such routing techniques would not account for this. Disclosed techniques allow for selective routing between NLG models of a same general type, including for queries having content suitable for processing by any of the NLG models to which queries can be routed.

Relatedly, disclosed techniques differ from routing queries based on a task type, in that a difficulty of a query is not assessed during routing based on task type. Rather, task-type routing decisions are hard coded, so that queries requesting a task of a type are routed to a specific AI model for that type. So, as described above, task difficulty may correspond more to the suitability of a given AI model for a given task rather than whether any specific query is more or less difficult.

### Example 2—Example Computing Environment for Adaptive Query Routing

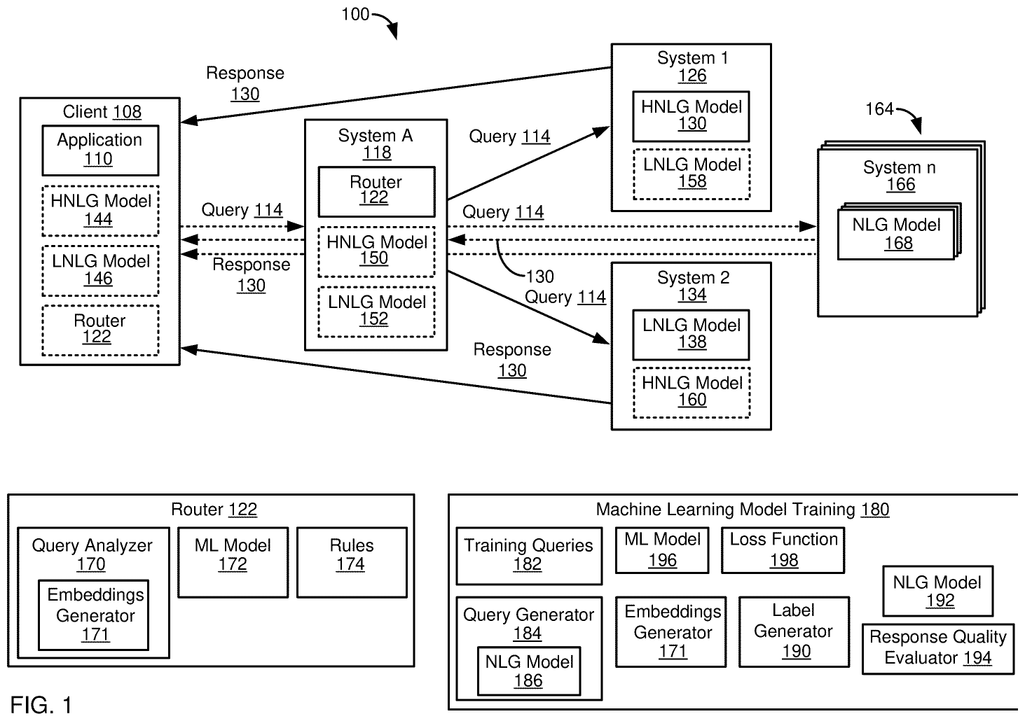

FIG. 1 illustrates an example computing environment 100 in which disclosed techniques can be implemented. The computing environment 100 generally includes an application 110 that can be used to submit queries to NLG models. The NLG models can be models that are less resource intensive (LNLG models) or are more highly resource intensive (HNLG models). As described in Example 1, disclosed techniques relate to analyzing queries from the application 110 using a router, to route the queries to a LNLG model or a HNLG model depending on a complexity/difficulty of the query.

The application 110, queries, router, at least one LNLG, and at least one HNLG are basic components of the computing environment 100. Beyond that, the computing environment 100 may have different components, communicating in different manners. FIG. 1 will be described with respective to a particular example use case, but alternative scenarios will also be described.

A client computing system 108 is shown as including the application 110. The application 110 can be any application that is configured to receive queries, or prompts, submit them for processing by a NLG model, and receive responses. As described, an application can be a “standalone” application, such as consumer-facing implementations of CHATGPT, but can also be an application that integrates NLG functionality, such as a spreadsheet program or a word processing program. Queries can be received from a user, or from another computing process. Similarly, responses can be provided to a user, or can be provided to another computing process. Queries can be sent, and responses received, using an API provided by a NLG model.

As shown, queries 114 are sent from the client computing system 108 to a computing system 118. In this scenario, the computing system 118 primarily serves to host a router 122. The router 122 is responsible for analyzing the query 114 to determine to which of a plurality of NLG models the query should be sent.

In the example scenario, the router 122 can send the query 114 to be processed by a computing system 126, which hosts a HNLG model 130, or a computing system 134, which hosts a LNLG model 138.

The computing system 100 can be modified in a variety of ways. For example, instead of being located at the computing system 118, the router 122 can be located at the client computing system 108. Locating the router 122 at the client computing system 108 can be particularly beneficial when one or more of the NLG models are located on the client computing system. Thus, the client computing system 108 is shown as potentially including the router 122 (shown in dashed lines), as well as including one or both of a HNLG model 144 or a LNLG model 146.

Often, client computing systems 110 may be comparatively constrained in resources, such as compared with cloud-based systems. In some examples, a client computing system 110 include the router 122 and the LNLG model 146, since that NLG model may run satisfactorily on the client computing system. If the router 122 determines that a query 114 is sufficiently difficulty, the router can forward the query to a HNLG model on another computing system, such as the HNLG model 130 of the computing system 126.

In another example, the router 122 is located on the computing system 118, and that computing system further includes one or both of a HNLG model 150 or a LNLG model 152. In one implementation of this scenario, the router 122 routes queries 114 between the models 150, and 152, and the system need not include the computing systems 126 and 134. In another example, the computing system 118 uses one of the NLG models 150, 152, and routes queries 114 to an NLG model of complimentary complexity (for example, a HNLG model, if the LNLG model 152 is used) of the computing systems 126 or 134.

In a further implementation, the computing system 126 or the computing system 134 can include both LNLG models and HNLG models. Computer system 126 is shown as including a LNLG model 158, while the computing system 134 is shown as including a HNLG model 160. In these scenarios, a single computing system of the computing system 126, 134 can be used. For example, the router 122 of the computing system 118 can route queries between the HNLG model 130 and the LNLG model 158.

The computing environment 100 can include more than two computing systems that host NLG models. The computing environment 100 is shown as including computing systems 164, up to an n^{th} computing system 166, where a given computing system of the computing systems 164 can include one or more NLG models 168, which can be HNLG models, LNLG models, or a combination thereof.

Responses 130 are provided in response to a query 114. In some cases, responses 130 are first provided by a computing system 126, 134, 164 to the system 118 hosting the router 122. The system 118 then sends the responses 130 to the client 108 for use by the application 110. In other cases, the computing systems 118, 126, 134, 164 can directly provide responses to the client 108, for use by the application 110.

FIG. 1 also provides additional details regarding the router 122. As shown, the router 122 includes a query analyzer 170, a machine learning model 172, and rules 174. The query analyzer 170 receives a query 114, and submits information about the query to the machine learning model 172. In a particular example, the query analyzer 170 submits the query 114 to an embeddings generator 171. The embeddings generator 171 can be a contextual embeddings generator, such as BERT (Bidirectional Encoder Representations from Transformers), De-BERTa (where the “De” stands for “disfluency”), or GloVe (Global Vectors for Word Representation). In other scenarios, static embedding techniques, such as Word2Vec, can be used. The embedding generator 171 provides a vector-space representation of the query. The present disclosures provides techniques that can assume that queries that have similar vector-space representations are of comparable difficulty.

Using the information about the query 114, such as the contextual embedding, the machine learning model 172 can classify the query in a difficulty category, or can assign a difficulty score to the query. The query analyzer 170 can use rules 174 to determine where the query 114 should be routed based on the output provided by the machine learning model 172.

The machine learning model 172 can provide various metrics that can be used for query routing. In a particular example, the machine learning model 172 provides a probability that a given query 114 corresponds to a query of a given difficult level, such as being an easy query. In other cases, the machine learning model 172 can provide a binary label of whether a query is easy or hard. However, it can be beneficial to provide a machine learning result that can take more than two values, as it can provide more flexibility in routing queries. For example, having a wider range of values allows for router tuning, which can be performed based on operational conditions (such as a load on a particular NLG model) or based on a desired level of resource savings. That is, in some cases it may be desirable to send more queries 114 to a less resource-intensive NLG model, even if the responses may be of lower quality (have a greater quality gap as compared with a HNLG).

A machine leaning model training component 180 can be used to provide the trained machine learning model 172. The machine learning model training component 180 uses a set of training queries 182. In some cases, the training queries 182, along with labels for the queries (as will be further described), are provided by a human. In other cases, one or both of the training queries 182 or the labels can be automatically generated.

In a particular implementation, the machine learning model training component 180 includes a query generator 184. The query generator 184 can include an NLG model 186 that generates queries. Queries can be generated by submitting suitable requests to the NLG model 186 (such as providing instructions to an LLM to generate queries, optionally with instructions as to the form or content of the query, including a type of task to be performed in answer the query).

In other implementations, the query generator 184 can use other techniques. Template-based query generation can be used, which employes predefined templates where specific keywords or phrases are inserted dynamically, offering a structured yet flexible approach to query creation. As another example, data-driven approaches can analyze existing datasets or query logs, enabling the generation of queries that reflect real user behavior or common query patterns. Rule-based systems can be used to generate queries based on a set of predetermined rules or heuristics, which can be tailored to specific domains or applications.

In another example, Markov models can be used. Markov models use probabilistic techniques, such as using chains of statistically likely word sequences to generate queries. These queries can capture inherent randomness and unpredictability in language use. Syntactic and semantic manipulation techniques for generating queries can be used, and involve altering existing queries or sentences, either by changing their structure (syntax) or meaning (semantics), to create new, varied query forms.

When unlabeled training queries 182 are provided, labels can be determined and applied to the queries using a label generator 190. Labels can take a variety of forms, but generally indicate a level of difficulty for a query. For example, the labels can be binary values that indicate whether a query is easy or difficult, or can represent a probability of a query being easy or difficult. In another example, labels can be applied, but can account for an adjustment factor when determining “hard” or probabilistic labels. These techniques are further described in Example 3.

In generating labels, the label generator 190 can use functionality of an NLG model 192 or a response quality evaluator 194. As will be further described in Examples 3 and 4, the NLG model 192, such as an LLM, can be provided with query results generated by a HNLG model and a LNLG model provided in response to a training query 182 and asked to evaluate or score the responses. Additional information can be provided to the NLG model 192, such as the training query 182 or instructions on how responses should be evaluated or scored.

The response quality evaluator 194 can use various techniques to measure the quality of a response provided by an NLG model. In one example, BERT scores are used. However, scores such as ROUGE (Recall-Oriented Understudy for Gisting Evaluation) or BLEU (Bilingual Evaluation Understudy) can also be used, although the quality of the evaluation can change depending on the technique used to measure response quality. Another score that can be calculated for query responses is a METEOR (Metric for Evaluation of Translation with Explicit Ordering) score. BART scores are another evaluation metric can be used (such as described in Yuan, et al., “BARTScore: Evaulating Generated Text as Text Generation, arXiv:2106.11520 (June 2021)). NLG models can also be used to evaluate responses, such as using a GPT model (such as GPT-4, from OPENAI). Human evaluation of responses can also be used in disclosed techniques.

When training an ML model 196 to provide the ML model 172 used in the router 122, embeddings for training queries 182 can be produced using the embeddings generator 171. The embedding for a training query 182 and its label are provided to the model 196 to provide a result. A measure of loss is calculated, and used to train the ML model 196. The training process can correspond to minimizing a loss function 198, where example loss functions are described in Example 3. Generally, the loss function 198 tries to correct results of the ML model 196 to be more consistent with a label provided for a training query 182.

### Example 3—Example Router Training and Implementation

This Example 3 provides a particular implementation of a machine learning based router implementation that routes between two NLG models, in particular LLM models, with different inference costs and accuracy. This allows NLG platforms (such as FACE, OPENAI, or C) to route queries across backend LLMs to lower costs while providing satisfactory responses to users. The routing also allows platforms to dynamically tune the ratio of queries assigned to each model. In one example, this dynamic tuning can be based on quality requirements or particular uses or applications, where some use may be more tolerant to lower quality responses than others. The describe routing techniques also allow users with small models on local (edge) devices to only call a remote, more expensive platform for hard queries, thus significantly reducing their expenses (which can be cost, in a financial sense, or costs in terms of latency or network use, or overall computing costs associated with query processing for a local device).

X and Z are used to denote the input query space and the set of all possible output responses respectively. L:X→Z denotes the large model, and S:X→Z denotes the small model. An objective is to learn a router r:X→{0, 1} such that each user query x∈X is routed to the small model S(x) if r(x)=0, and to the large model L(x), otherwise. Here, 0 indicates an easy query and 1 indicates a hard query. The routing technique results in a query being routed to a single NLG model at inference time, as opposed to using an ensemble or a cascade of NLG models, which may call multiple NLG models to resolve a single query and incur significant computational overheads.

Various techniques can be used to evaluate the text of a query response by a NLG model to a query. Metrics, such as BLEU and ROUGE, initially designed for machine translation and summarization, can be used. However, other techniques can be used and may provide better results. In one example, rankings can be determined using an LLM, such as using GPT-rankings (Generative Pretrained Transformer, as used in products available from OPENAI). In particular, GPT-4 (OPENAI) can be used to provide relative rankings between pairs of generated outputs. However, these techniques can have computational costs and may not sufficiently distinguish between examples with similar qualities.

In a particular example, disclosed techniques use a BART score (Binary All-Subsequence Regression Transformer) to evaluate response quality of different models. BART scores are beneficial in that they can be comparatively inexpensive to compute, and the results can compare well with “ground truth” rankings. A ground truth ranking can correspond to a human's classification of response quality. As will be described as the specification proceeds, a ground truth ranking can be provided in an automated manner, but where typically the results of the automated ranking correlate reasonably well with human generated rankings. The BART score (response quality) can be denoted using q(z), q:Z→ [symbol] , of model responses z∈Z.

A cost of a model (such as an NLG model) may or may not be known with precision. In general, costs can be expressed using a variety of metrics, including latency, FLOPs, or energy consumption. Further, in NLG inference, each of these metrics can affected by several underlying variables, such as different prompt templates, hardware capability, or network connectivity. That is, for example, different prompt templates can affect computer resource used, while network connectivity can influence latency, beyond contributions an NLG model itself to inference costs for a particular query. In additions, some cost metrics may be more or less relevant in different use cases.

In some cases, a size of a model can be used as a measure of model cost. That is, an assumption can be made that inference using smaller models is more efficient than larger models. Thus, an improvement in one or more cost metrics can be expected by routing more queries to the smaller model. Cost advantage can be defined as the percentage of queries routed to the smaller model. However, disclosed techniques can be used to route queries between two different models based on query difficulty using other measures of model cost.

Queries for which the response quality of the small model (or otherwise “less costly” model) is close to the response quality of the large model (or otherwise “more costly” model) can be referred to as “easy” queries. An example of an “easy” query is “Rewrite the following sentence in the present tense. I went to the store.” Both smaller and larger models can provide the identical response of “I am going to the store.”

As an example of a “hard query,” consider the open-ended question “What are the benefits of having a dog?” A smaller model may generate a response such as “A dog is good for physical activity.” On the other hand, a larger model may generate a more complete and detailed response, such as:

Having a dog can bring numerous benefits to your life, including:
1. Companionship: Dogs are known for their loyalty and companionship. They provide emotional support and can help alleviate loneliness.
2. Physical Activity: Owning a dog encourages physical activity. Daily walks, playtime, and exercise routines with your dog help you stay active and maintain a healthy lifestyle.
3. Mental Health: Interacting with dogs can reduce stress, anxiety, and depression. They can boost your mood and provide a sense of purpose and responsibility.
4. Social Connections: Dogs can be excellent conversation starters, leading to increased social interactions with other dog owners and people in your community.
5. Unconditional Love: Dogs offer unconditional love and affection. They don't judge and provide a source of constant love and comfort.
6. Security: Many dogs can provide a sense of security and protection, alerting you to potential threats or intruders.
7. Routine: Dogs thrive on routine, which can help you establish and maintain a structured daily schedule.
8. Learning Responsibility: Caring for a dog teaches responsibility, as you need to provide food, exercise, grooming, and healthcare.
9. Emotional Support: Dogs have been shown to sense and respond to human emotions, providing comfort during difficult times.
10. Therapeutic Benefits: Some dogs are trained as therapy or service animals, providing assistance and support to individuals with specific needs, such as those with disabilities or medical conditions.
11. Happiness: The presence of a dog can bring joy and happiness into your life. Their playful nature and antics can be entertaining and heartwarming.
12. Reduced Allergies: Studies suggest that early exposure to dogs may reduce the risk of allergies and asthma in children.
13. Sense of Purpose: Owning a dog can give you a sense of purpose, as you provide for their needs and well-being.
It's important to note that owning a dog also comes with responsibilities, including time, effort, and financial commitments for their care. Different dog breeds have varying needs and characteristics, so it's essential to choose a dog that matches your lifestyle and preferences. Overall, the decision to have a dog should be based on your readiness and willingness to provide love and care to a furry companion.

It can be seen that the larger model provides a significantly more detailed example, which both a human and an automated process may score as being of higher quality than the response provided by the smaller model.

As discussed, disclosed techniques provide a router that dynamically identifies easy queries and routes them to the small model, thereby providing significant inference cost reduction without much drop in response quality. Note that the easy queries as defined here need not necessarily be queries that are easy/inexpensive to respond to, they are just queries for which the small model can match up to the large model. Further, more generally, and as noted above, disclosed techniques relate to routing queries between two or more NLG models based on an expected difference in response quality, but routing criteria need not necessarily be “size.” For example, it may be beneficial to route queries to a particular NLG model, such as a local model, if the performance is reasonably equivalent to another NLG model, without regard to the model size, and even if a “preferred” model for easy queries is larger than the other model.

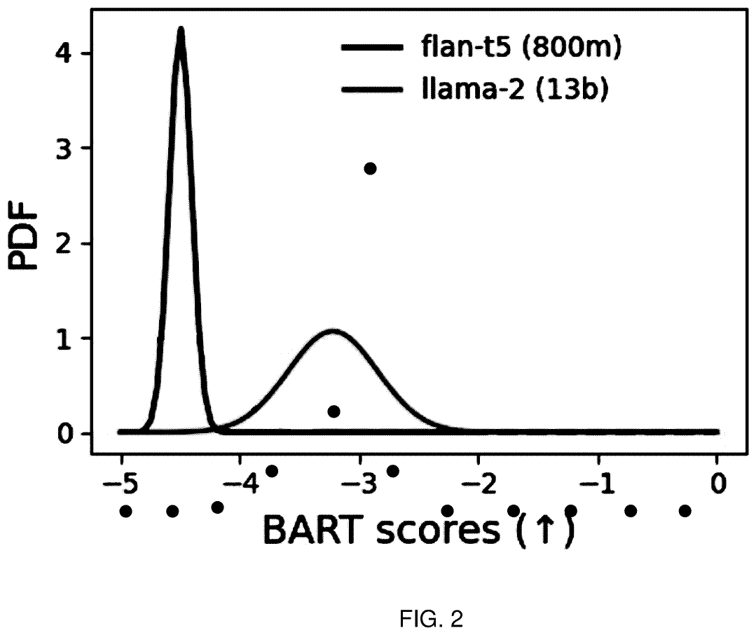

For a pair of NLG models, a quality gap of a query x can be defined as H(x):=q(S(x))−q(L(x)). In other words, the quality gap is the difference in quality of the small model's response S(x) and the large model's response L(x). The quality gap can be a random variable since NLG responses are typically non-deterministic. That is, different responses can be provided by the same model for different requests for the same query. This is illustrated in FIG. 2, where it was observed that the llama-2 model provided higher quality responses for a given query than the FLAN-t5 model.

In the specific technique of this Example 3, queries are routed using a BERT-style encoder model, which is trained on a dataset of representative queries. That is, as explained in Example 2, BERT or similar vector-space embeddings are used as input during inference, as well as being used in model training. The encoded model learns to predict a score for an input query. Since the router is an encoder model, a single pass of the query through it is sufficient to generate the score. In some cases, the cost of the routing determination can be considered negligible compared to the cost of generating a query response using the larger model. Thus, it can be expected that using the router to route queries to the small model will not detract significantly from its cost advantage.

A router score can be calculated so as to be large for easy queries as defined above. An estimate of the probability of the quality gap being greater than or equal to zero (Pr[H(x)≥0]) is a suitable candidate to be routed to the small model, since a large value of that probability is equal to the probability of the small model having a quality that is greater than or equal to the large model (Pr[H(x)≥0]=Pr[q(S(x))≥q(L(x))])).

However, it may be beneficial to route queries to the smaller model even if the results are not at least as good as for the large model. However, if the anticipated quality drops too much, the query will be routed to the large model. Stated another way, in scenarios where the large model is significantly more powerful than the small model (q(S(x))<<q(L(x))), the definition of easy queries can be relaxed to Pr[H(x)≥−t]=Pr[q(S(x))≥q(L(x))−t] for an appropriate t>0. In this case, t is positive threshold that serves as a cut off point for routing queries to the large model. Or, stated another way, queries will continue to be routed to the small model so long as the expected quality of the small model is not more than t less than the quality provided by the large model.

Thus, during use, a desired level of performance accuracy tradeoff as compared with query cost can be achieved by tuning a threshold on the score, and routing queries with scores above the threshold to the small model. For a router with parameters w, we denote router score by p_{w}(x), p_{w}:χ→[0, 1]. In other words, a router score is calculated for a given query x, in a query space χ, and the value is either 0 or 1, which the two values corresponding to two different NLG models available for use. Different router score designs are discussed assuming a training set of N queries x1, . . . , x_{N}.

To simplify analysis, an assumption can be made that NLG models are deterministic functions that map queries (as represented by a vector-space embedding) to a single response in an output space. In practice, this can be reflected by obtaining a single response per query from each model. Boolean labels (yᵢ^{det}) can be assigned to each training query according to:

$${y}_{i}^{det} = 𝕀 [ q ( S ( {x}_{i} ) ) \geq q ( L ( {x}_{i} ) ) ] , i = 1 , … , N$$

where [symbol] is an indicator function (providing a value of 0 or 1). The BART score corresponds to the quality function q(·).

An example router is trained by minimizing the binary cross-entropy loss:

$$ℒ ( w ) = - \frac{1}{N} {\sum }_{i = 1}^{N} {y}_{i}^{det} log ( {p}_{w} ( {x}_{i} ) ) + ( 1 - {y}_{i}^{det} ) log ( 1 - {p}_{w} ( {x}_{i} ) )$$

where [symbol] (w) is the loss function (dependent on parameters w of the model) and p_{w} is the probability predicted by the router for the query xᵢ. In this equation, the loss function L(w) is influenced by the predicted probabilities p_{w}(xᵢ) from the router for each query xᵢ. The labels yᵢ^{det} are binary indicators where a value of 1 suggests the query is “easy” and can be satisfactorily handled by the smaller model. Conversely, a value of 0 indicates a “hard” query, better suited for the larger model.

The loss function is structured such that if the label yᵢ^{det} is 1, the loss is minimized when p_{w}(xᵢ) is maximized (since the second term in the summation drops out), encouraging the router to correctly classify easy queries. If yᵢ^{det} is 0, the loss is minimized when p_{w}(xᵢ) is minimized (since the first term in the summation drops out), which correctly identifies hard queries. This technique provides that the router's predictions align with the pre-determined difficulty levels of the queries.

The assigned labels yᵢ^{det} can be viewed as an estimate for Pr[H(xᵢ)≥0] given a single response per query from each model, thus minimizing the above loss encourages the router score p_{w}(x) to be close to Pr[H(x)≥0] for test queries. This deterministic router is referred to as r_{det}.

Note that the assumption that AI models generate a single output per query is more justified for tasks where the ground truth labels are often explicit and unique, such as image classification and video segmentation. In many cases, for NLP tasks, such as using NLG models, there may not be a single output per query, which can be due to the intrinsic ambiguity and complexity of natural languages. LLMs can be used as non-deterministic generators to capture the intrinsic uncertainty of NLP tasks, as shown in FIG. 2. The non-determinism mainly comes from the randomness in the decoding phase.

Decoding, in this context, refers to the process of generating human-readable text or responses based on a given input or prompt (referred to herein as a query). Decoding strategies are techniques and approaches used to determine how this text generation process occurs. In some cases, users can control the level of uncertainty for an LLM by choosing different decoding strategies, such as nucleus sampling. Nucleus sampling involves selecting words or tokens for the generated text from a fixed portion of the probability distribution of possible words.

Users can also control a level of uncertainty by selecting a value for a hyper-parameter temperature. The hyper-parameter temperature controls the extent of randomness in the generated text. Higher temperature values result in a higher level of randomness and diversity among the generated responses, while lower values make the text generation more focused and deterministic. It can be expected that higher temperature values will result in a higher level of randomness and diversity among the generated responses. For black-box LLM APIs such as GPT-4 (OPENAI), it has been observed that even upon setting temperature to the minimum value 0, it can still provide different responses for the same input queries.

In one implementation, uncertainty resulting from the non-deterministic nature of NLG, such as LLM, comparisons can incorporated into the router training by relaxing the hard labels yᵢ^{det}∈{0, 1} to soft labels yᵢ^{prob}:=Pr[H(xᵢ)≥0]= [symbol] [ [symbol] [q(S(xᵢ))≥q(L(xᵢ))]], where [symbol] denotes the expectation (a measure of the central tendency or the average value that random variable takes, such as the sum of all possible values, each multiplied by the probability of its occurrence). This expected value is obtained by sampling multiple responses from each model and averaging the outcomes of the indicator function. For example, [symbol] can be estimated by sampling 10 responses from each model and computing the sample average of the corresponding indicator function values. Note that the hard label yᵢ^{det} is a higher variance estimate of [symbol] [ [symbol] [q(S(xᵢ))≥q(L(xᵢ))]]](since it is obtained from a single sample). That is, while hard labels are constrained to be between 0 and 1, soft labels can have continuous values ranging between 0 and 1, allowing a value to represent query difficulty more precisely. Accordingly, improved performance can be expected with the following training loss,

$$ℒ ( w ) = - \frac{1}{N} {\sum }_{i = 1}^{N} {y}_{i}^{prob} log ( {p}_{w} ( {x}_{i} ) ) + ( 1 - {y}_{i}^{prob} ) log ( 1 - {p}_{w} ( {x}_{i} ) )$$

This probabilistic router can be referred to as r_{prob}.

In some cases, the empirical estimate of Pr[H(xᵢ) [symbol] [ [symbol] q(S(xᵢ)≥q(L(xᵢ))] tends to be extremely small when the large model is significantly more powerful than the small model (0 for almost 90% of the queries in FIG. 2 with Flan-t5 (800 m) as the small model and Llama-2 (13b) as the large model). Because q(S(x))<<q(L(x)) in some cases, the estimate of the probability may provide relatively weak training.

Since class labels are primarily used for routing decision, new labels can be defined that can provide for stronger training, and correspondingly improved query routing. In particular, transformed labels yᵢ^{trans} can be defined as yᵢ^{trans}(t):=Pr[H(x)≥−t]=Pr[q(S(x))>q(L(x))−t] for some t>0. Since −t<0, Pr[H(ₓ)≥−t]≥Pr[H(x)≥0] by definition of the tail distribution. Thus, the relaxation of the labels can provide a stronger signal for router training while still allowing easy queries to be identifier—those queries for which q(S(x)) has a high likelihood of being close to q(L(x)), or Pr[(q(S(x))≥q(L(x))−t)]. Visually, this corresponds to comparing the distribution of the small model's response with a shifted distribution of the large model's response to a query (such as, in FIG. 2, leftward shifting the curve for llama-2).

Regarding the selection of t, given that tail probability Pr[H(x)≥−t] lies in [0, 1], t can be chosen by maximizing the average pairwise differences between the transformed labels to push them as far apart as possible and provide a strong signal for training. Thus, a maximize t, t*, can be determined as:

$${t}^{*} = \begin{matrix}arg max \\ t\end{matrix} \frac{1}{{N}^{2}} {\sum }_{( i , {i}^{′} )} \vert {y}_{i}^{trans} ( t ) - {y}_{{i}^{′}}^{trans} ( t ) \vert$$

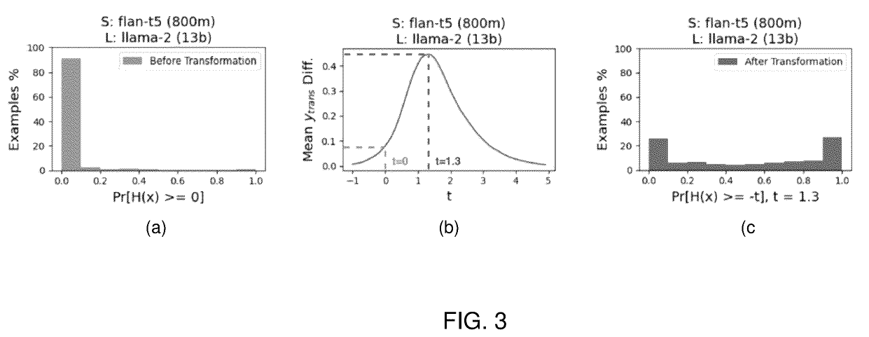

This optimization problem can be solved by a grid-search, or other approaches. The optimization objective for different values of t for a training dataset and the distribution of transformed labels yᵢ^{trans} is shown in graph (c) of FIG. 3, where graph (a) provides values prior to transformation and graph (b) represents the grid search. The distribution is significantly more balanced, and thus the router is expected to be more effective. The router can again be trained by minimizing loss

$$ℒ ( w ) = - \frac{1}{{N}^{2}} {\sum }_{( i , {i}^{′} )}^{1} ( {y}_{i}^{trans} ( {t}^{*} ) log ( {p}_{w} ( {x}_{i} ) ) + ( 1 - {y}_{i}^{trans} ) ( {t}^{*} ) log ( 1 - {p}_{w} ) ( {x}_{i} ) )$$

This probabilistic router is referred to as rₜᵣₐₙₛ.

Additional details regarding disclosed technologies, including evaluation results, can be found in openreview.net/pdf?id=02f3mUtqnM, incorporated by reference herein in its entirety to the extent not inconsistent with the present disclosure.

### Example 4—Example Automated Labelling of Training Queries

As has been described, in at least some embodiments, an AI model is used to classify queries as easy or hard, or to generate a score for a query that can be used to classify a query as easy or hard. Certain of these models are trained using a supervised learning technique, where example queries are provided along with a training label in the form of an easy/hard classification or a score. While manual labelling of queries can be used, it can be challenging to generate enough training data to train an AI model to a desired degree.

Accordingly, the present disclosure provides various techniques that can be used to automatically label training queries. In one implementation, it is assumed that the larger model, or otherwise more computationally expensive model, or other model designated for processing hard queries, provides the “correct” response. In this scenario, the complexity of a query can be determined by comparing how closely the response of the smaller model corresponds to the response of the larger model. Again, easy queries can be defined as those where the smaller model provides a response of similar quality to the quality of the response provided by the larger model.

However, this technique can have various drawbacks. Despite having more complex models, and potentially, additional processing functions, in some cases large models can produce results that are inferior to smaller models. This discrepancy in some cases can relate to the nature of a query, such as whether the query is one that expresses an “open question,” which may not have a single correct answer. That is, problems can arise if the large model is always assumed to have a “better” response, as fewer queries will be routed to the smaller model, even if a human might determine the response of a small model to be equivalent or even superior to a response provided by a larger model.

As an example of how additional processing modes available to a more complex/larger model can result in inferior query results compared to those from a smaller model, some more complex models can have functionality to directly access information beyond what was used in a training data set. For example, some models may have the ability to analyze files or images provided in a query, or to independently access internet resources. Taking the ability to access internet resources, while in some cases this can allow a model to provide superior answers, including answering questions that require information developed after the latest date of information in the training data set, in some cases content retrieved from the internet can provide a response that is inferior to that which could have been generated by the larger model based only on the parameters learned from the training data set. Thus, even a less complex model that does not use internet resources to answer a query can produce results that are superior to the large model.

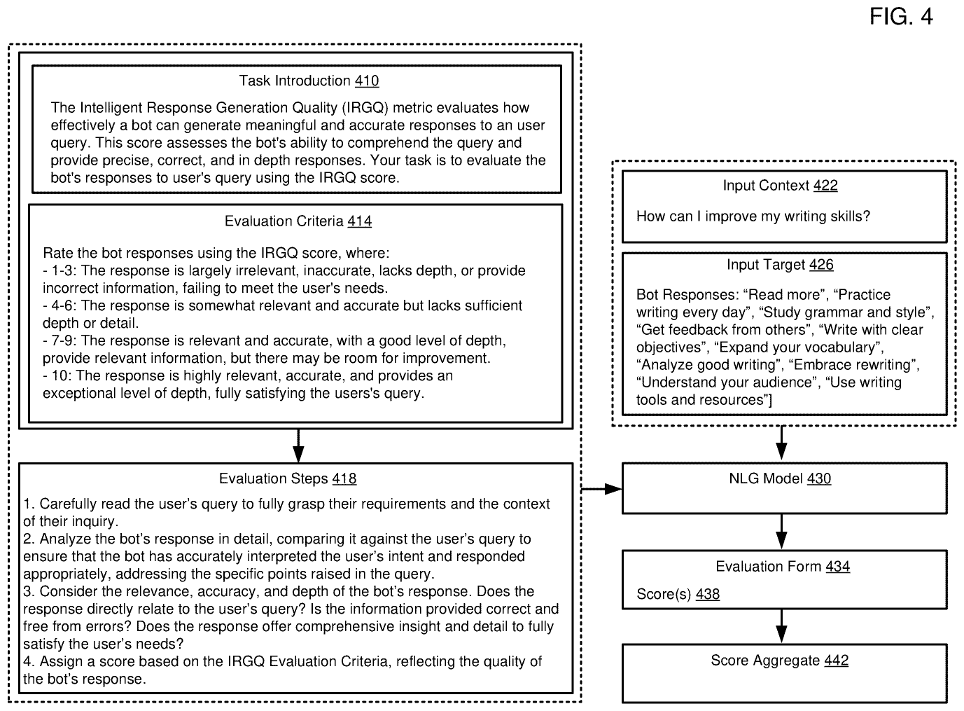

In one example, the present disclosure provides a technique where an NLG model, which can be one of the models to which queries will be routed or another model, is used to analyze generated responses based on a set of criteria, such as is illustrated in FIG. 4. An NLG model can be provided with input of a task introduction 410 and evaluation criteria 414. The task introduction 410 provides an overview of a task to be performed by a NLG model in evaluating query responses, assessing whether the NLG response indicates that the NLG model correctly assessed the query and an assessment of the accuracy, precision, and depth of the NLG response. Evaluation criteria 414 more specifically define how the task is to be performed.

The task introduction 410 and the evaluation criteria 414 can be provided to an NLG model to produce a set of evaluation steps 418 to be performed by the NLG model used for query evaluation, where the evaluation steps are consistent for at least queries of a similar type in a set of training data. That is, in at least some embodiments, different types of training data can be used in training a router. Some types of training data may have labels already assigned, and so the technique of FIG. 4 may not be needed. Similarly, query responses for other types of queries may benefit from scoring or classification using a different technique (or using the technique of FIG. 4, but with different task definition, evaluation instructions/criteria, or evaluation steps). As noted in the evaluation criteria, the score (IRGQ score—Intelligent Response Generation Quality) can take into account additional assessment criteria, such as relevancy.

In FIG. 4, an “input context” 422 (a training query) is provided to the small LLM and the large LLM to generate respective input targets 426 (only one of which is shown in FIG. 4). An NLG model 430 that performs scoring then analyzing the input context 422 and a respective input target 426 (in the form of multiple responses provided by the NLG, which can be aspects of a response to a single query or an aggregation of multiple responses to repeated input of the same query) using the evaluation steps 418 to produce an evaluation 434 that includes one or more scores 438, or, more generally, a classification or categorization of responses provided by the large or small model, or the relative performance of the models.

The scores 438 can be used to determine whether the small model performed better than, equivalent to, or worse than the large model. The response having the highest score 438, in some cases, can be selected as the “correct” response. The techniques described in Example 3 can be adapted to use these scores in place of the BART scores. However, in at least some cases it can be useful to determine correctness using a BART score or similar score that does not employ an NLG model. Generally, BART scores are consistent with quality ratings of other techniques, and of human evaluation, but are less resource intensive to generate than scoring using NLG models.

Since at least some NLG models are non-deterministic, the query response generation and scoring process can be performed multiple times, and these scores can then be compared to determine which model generated the “correct” response to the query, such as being used to generate a score aggregate 442. For example, a probability or confidence value for a score can be multiplied by a given score, and the resulting values summed for all of the generated responses. The average value of the scores can then be used as the score for a particular query for a particular NLG model.

In many cases, NLG models produce multiple candidate responses for a given query. The candidate responses can be evaluated by the NLG model and a top response provided as the response to the query. These evaluations can include scoring of candidate responses for quality, relevance, or coherence. In this case, rather than generating separate “top” query responses for multiple inputs of the query, a number of the candidate responses can be selected for use in the scoring process. Since the candidate responses are generated as part of generating a single selected query response, this technique can be more computationally efficient than inputting the same query to a model multiple times.

Various aspects of the NLG model can be adjusted for use in the scoring process, as desired, such as when interacting with the model using an API that provides more control over the operation of the NLG model. For example, a “temperature” of the NLG model can be adjusted, such as to increase or decrease the amount of randomness or creativity in responses. In particular examples, the temperature is set to a relatively low value, meaning that responses are comparatively deterministic (the model will generate the same or more similar responses to a given query). Similarly, a “p” value of the NLG model can be adjusted, where the p value is associated with nucleus sampling. That is, when selecting words in a response, words or tokens are selected for a response up to a cumulative probability p. A p value of 1 indicates that the most probable words are being selected for a response, while lower p values provide a wider range of choices.

Just as manually labelling or scoring queries can be time consuming, and may be impracticable for larger data sets, so to can be generating queries in the first place. Accordingly, NLG models can also be used to generate queries. The queries can be randomly generated, or generated according to a specific set of instructions, such as a query type (for example, providing a factual response as opposed to generating or summarizing content). In yet another implementation, queries can be generated using a crowdsourcing platform, such as AMAZON MECHANICAL TURK (AMAZON.COM, Inc.)

This approach can be extended to provide particularly realistic queries and query patterns. For example, given the conversational nature of NLG models, particularly LLMs, users often engage in conversations with a model that continue over time, and can loop back to prior queries/responses, rather than simply having a series of discrete queries. These conversations can be replicated by having a single NLG model both generate and respond to its own queries, or having multiple NLGs interact, such as having one NLG model generate queries, another NLG model generate responses, and where the query generation model can generate further queries based on a response. Or, the two NLG models can alternate generation of queries and responses.

### Example 5—Example Operations Implementing Disclosed Technologies

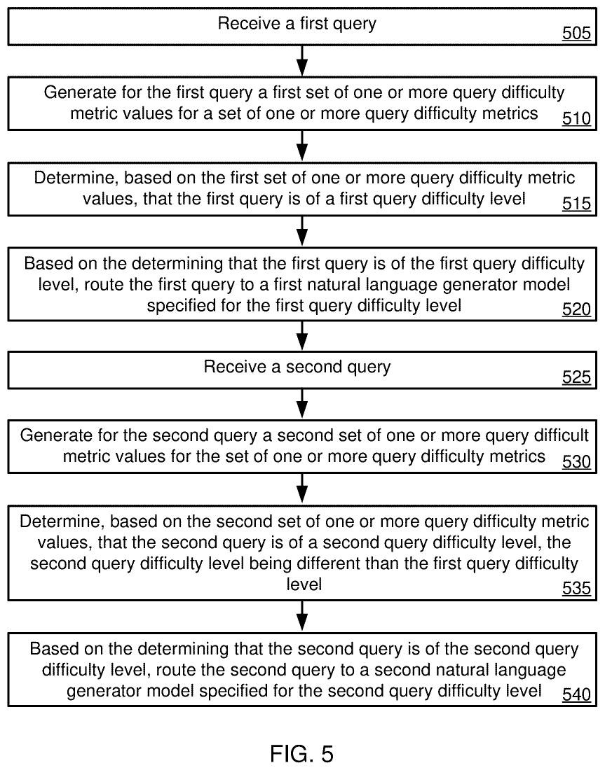

FIG. 5 is a flowchart of a process 500 of performing adaptive query routing using disclosed techniques. A first query is received at 505. At 510, a first set of one or more query difficulty metric values for a set of one or more query difficulty metrics are generated for the first query. It is determined at 515, based on the first set of one or more query difficulty metric values, that the first query is of a first query difficulty level. At 520, based on the determining that the first query is of the first query difficulty level, the first query is routed to a first natural language generator model specified for the first query difficulty level.

A second query is received at 525. At 530, a second set of one or more query difficulty metric values for the set of one or more query difficulty metrics are generated for a second query. It is determined at 535, based on the second set of one or more query difficulty metric values, that the second query is of a second query difficulty level, the second query difficulty level being different than the first query difficulty level. At 540, based on the determining that the second query is of the second query difficulty level, the second query is routed to a second natural language generator model specified for the second query difficulty level.

### Example 6—Example Operations Implementing Disclosed Technologies

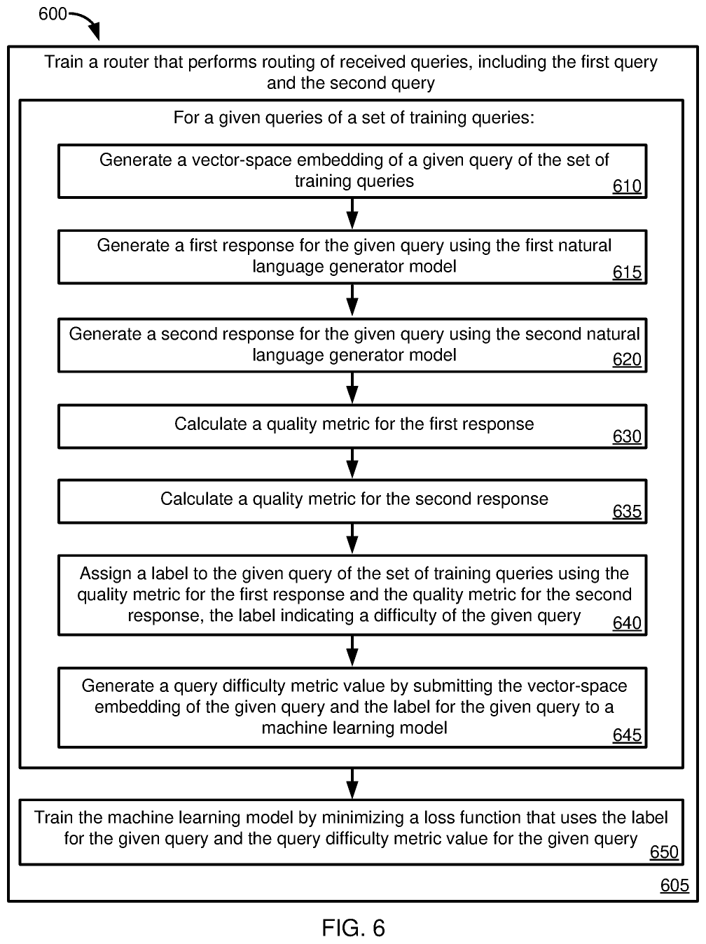

FIG. 6 is a flowchart of a process 600 of training a router that can perform adaptive query routing using techniques according to the present disclosure. At 605 a router is trained that performs routing of received queries to a determined natural language generator model of a plurality of available natural language generator models. The training includes performing various operations for given queries of a set of training queries.

The operations include, at 610, generating a vector-space embedding of a given query of the set of training queries. A first response for the given query is generated at 615 using a first natural language generator model of the plurality of available natural language generator models. At 620, a second response for the given query is generated using a second natural language generator model of the plurality of available natural language generator models.

A quality metric for the first response is calculated at 625. A quality metric for the second response is calculated at 630. At 635, a label is assigned to the given query using the quality metric for the first response and the quality metric for the second response. The label indicates a difficulty of the given query. A query difficulty metric value is generated at 640 by submitting the vector-space embedding of the given query and the label for the given query to a machine learning model.

At 645, the machine learning model is trained to provide a trained machine learning model by minimizing a loss function that uses the label for the given query and the query difficulty metric value for the given query. The router includes the trained machine learning model and selectively routes less difficult queries to the first natural language generator model, saving computing resources compared with processing the less difficult queries using the second natural language generator model.

### Example 7—Example Technical Advantages

Disclosed techniques can provide a number of technical advantages that solve the technical problem of high computing resource use for processing of queries by NLGs, particularly when such queries could be satisfactorily answered using a less resource-intensive NLG model. For queries where a less resource intensive NLG model can provide an acceptable response, routing the queries to such model rather than a more resource intensive model can save significant computing resources, reducing the burden on more complex, resource intensive systems, and making them more available for processing queries where a higher quality response from the more resource intensive NLG model make its use justified. Compared with other types of routing, disclosed techniques can also be beneficial as they can save computing resources without a significant loss of response quality. That is, users do not receive low quality responses just because a less resource intensive NLG model was used, since the queries are “filtered” so that the less resource intensive NLG model will provide a response of acceptable quality.

In fact, in some cases, manually reviewing a query may lead to a conclusion that a particular query is “difficult,” but where in fact a less resource intensive NLG model provides higher quality results than a more resource intensive NLG model. Disclosed techniques, such as through the use of a query classifier, can provided improved query responses for certain queries even as compared with using the more resource intensive NLG model for all queries.

### Example 8—Additional Examples

Example 1 is a computing system that includes at least one memory and at least one hardware processor that is coupled to the at least one memory. The computing system further includes one or more computer-readable storage media storing computer executable instructions that, when executed, cause the computing system to perform routing operations for natural language generator models that reduce computing resource use for certain queries without a significant decrease in query response quality. The operations include receiving a first query. A first set of one or more query difficulty metric values for a set of one or more query difficulty metrics are generated for the first query. It is determined, based on the first set of one or more query difficulty metric values, that the first query is of a first query difficulty level. Based on the determining that the first query is of the first query difficulty level, the first query is routed to a first natural language generator model specified for the first query difficulty level.

A second query is received. A second set of one or more query difficulty metric values for the set of one or more query difficulty metrics are generated for a second query. It is determined, based on the second set of one or more query difficulty metric values, that the second query is of a second query difficulty level, the second query difficulty level being different than the first query difficulty level. Based on the determining that the second query is of the second query difficulty level, the second query is routed to a second natural language generator model specified for the second query difficulty level.

Example 2 includes the subject matter of Example 1, and further specifies that the operations include generating a vector-space embedding of the first query. The vector-space embedding is submitted to a machine learning model to provide at least one query difficulty metric value of the one or more query difficulty metrics for the first query.

Example 3 includes the subject matter of Example 1 or Example 2, and further specifies that a query difficulty metric of the one or more query difficulty metrics corresponds to a probability of an evaluated query having the first query difficulty level.

Example 4 includes the subject matter of Example 3, and further specifies that the determining, based on the first set of one or more query difficulty metric values, that the first query is of a first query difficulty level, includes comparing the probability to a threshold probability, and the first query is routed to the first natural language generator model based on determining that the probability satisfies the threshold probability.

Example 5 includes the subject matter of Example 1, and further specifies that the operations include training a router that performs routing of received queries, including the first query and the second query. The training includes, for given queries of a set of training queries, generating a vector-space embedding of a given query of the set of training queries. A first response is generated for the given query using the first natural language generator model. A second response is generated for the given query using the second natural language generator model. A quality metric is calculated for the first response. A quality metric is calculated for the second response. A label is assigned to a given query of the set of training queries using the quality metric for the first response and the quality metric for the second response, the label indicating whether the given query has the first difficulty level or the second difficulty level. A query difficulty metric value is generated by submitting the vector-space embedding of the given query and the label for the given query to a machine learning model. A loss function is minimized that uses the label for the given query and the query difficulty metric value for the given query.

Example 6 includes the subject matter of Example 1, and further specifies that the operations include training a router that performs routing of received queries, including the first query and the second query. The training includes, for given queries of a set of training queries, generating a vector-space embedding of a given query of the set of training queries. A first response is generated for the given query using the first natural language generator model. A second response is generated for the given query using the second natural language generator model. A quality metric is calculated for the first response. A quality metric is calculated for the second response. A label is assigned to a given query of the set of training queries using the quality metric for the first response and the quality metric for the second response, the label indicating a probability of the quality metric for the first response being at least as high as the quality metric for the second response. A query difficulty metric value is generated by submitting the vector-space embedding of the given query and the label for the given query to a machine learning model. A loss function is minimized that uses the label for the given query and the query difficulty metric value for the given query.

Example 7 includes the subject matter of Example 1, and further specifies that the operations include training a router that performs routing of received queries, including the first query and the second query. The training includes, for given queries of a set of training queries, generating a vector-space embedding of a given query of the set of training queries. A first response is generated for the given query using the first natural language generator model. A second response is generated for the given query using the second natural language generator model. A quality metric is calculated for the first response. A quality metric is calculated for the second response. A label is assigned to a given query of the set of training queries using the quality metric for the first response and the quality metric for the second response, the label indicating a probability of the quality metric for the first response being at least as high as the quality metric for the second response minus an adjustment value. A query difficulty metric value is generated by submitting the vector-space embedding of the given query and the label for the given query to a machine learning model. A loss function is minimized that uses the label for the given query and the query difficulty metric value for the given query.

Example 8 includes the subject matter of Example 1, and further specifies that the operations include training a router that performs routing of received queries, including the first query and the second query. The training includes, for given queries of a set of training queries, generating a vector-space embedding of a given query of the set of training queries. A first response is generated for the given query using the first natural language generator model. A second response is generated for the given query using the second natural language generator model. A quality metric is calculated for the first response. A quality metric is calculated for the second response. A label is assigned to the given query of the set of training queries using the quality metric for the first response and the quality metric for the second response, the label indicating a difficulty of the given query. A query difficulty metric value is generated by submitting the vector-space embedding of the given query and the label for the given query to a machine learning model. A loss function is minimized that uses the label for the given query and the query difficulty metric value for the given query.

Example 9 includes the subject matter of Example 8, and further specifies the calculating the quality metric for the first response is performed by a third natural language generator model, wherein the third natural language generator model is the first natural language generator model, the second natural language generator model, or is a natural language generator model other than the first natural language generator model and the second natural language generator model.

Example 10 includes the subject matter of Example 9, and further specifies that the operations further includes submitting the first response to the third natural language generator model with instructions on how the quality metrics for the query responses are to be calculated.

Example 11 includes the subject matter of Example 1, and further specifies that the operations include training a router that performs routing of received queries, including the first query and the second query. The training includes, for given queries of a set of training queries, assigning a label to a given query of the set of training queries, that label indicating whether the given query has a first difficulty level or a second difficulty level. A vector-space embedding of a given query of the set of training queries is generated. A first response is generated for the given query using the first natural language generator model. A second response is generated for the given query using the second natural language generator model. A quality metric is calculated for the first response. A quality metric is calculated for the second response. A query difficulty metric value is generated by submitting the vector-space embedding of the given query and the label for the given query to a machine learning model. A loss function is minimized that uses the label for the given query and the query difficulty metric value for the given query.

Example 12 includes the subject matter of Example 11, and further specifies that the operations include receiving user input assigning the label to the given query.

Example 13 is a method that is implemented in a computer system that includes at least one memory and at least one hardware processor that is coupled to the at least one memory. The method includes training a router that performs routing of received queries to a determined natural language generator model of a plurality of available natural language generator models. The training includes, for given queries of a set of training queries, generating a vector-space embedding of a given query of the set of training queries. A first response for the given query is generated using a first natural language generator model of the plurality of available natural language generator models. A second response for the given query is generated using a second natural language generator model of the plurality of available natural language generator models. A quality metric is calculated for the first response. A quality metric is calculated for the second response. A label is assigned to the given query using the quality metric for the first response and the quality metric for the second response, the label indicating a difficulty of the given query. A query difficulty metric value is generated by submitting the vector-space embedding of the given query and the label for the given query to a machine learning model. The machine learning model is trained to provide a trained machine learning model by minimizing a loss function that uses the label for the given query and the query difficulty metric value for the given query. The router includes the trained machine learning model and selectively routes less difficult queries to the first natural language generator model, saving computing resources compared with processing the less difficult queries using the second natural language generator model.

Example 14 includes the subject matter of Example 13, and further includes generating at least a portion of the set of training queries using a third natural language generator model.

Example 15 includes the subject matter of Example 13 or Example 14, and further specifies that calculating the quality metric for the first response is performed by a third natural language generator model, where the third natural language generator model is the first natural language generator model, the second natural language generator model, or is a natural language generator model other than the first natural language generator model and the second natural language generator model.

Example 16 includes the subject matter of Example 15, and further includes submitting the first response to the third natural language generator model with instructions on how the quality metrics for the query responses are to be calculated.

Example 17 incorporates the subject matter of any of Examples 13-16, and further specifies that the label assigned to the given query indicates that the given query has a first difficulty level or a second difficulty level.

Example 18 incorporates the subject matter of any of Example 13-16, and further specifies that the label indicates a probability of the quality metric for the first response being at least as high as the quality metric for the second response.

Example 19 incorporates the subject matter of any of Examples 13-16, and further specifies that the label indicates a probability of the quality metric for the first response being higher than the quality metric for the second response minus an adjustment value.

### Example 9—Computing Systems

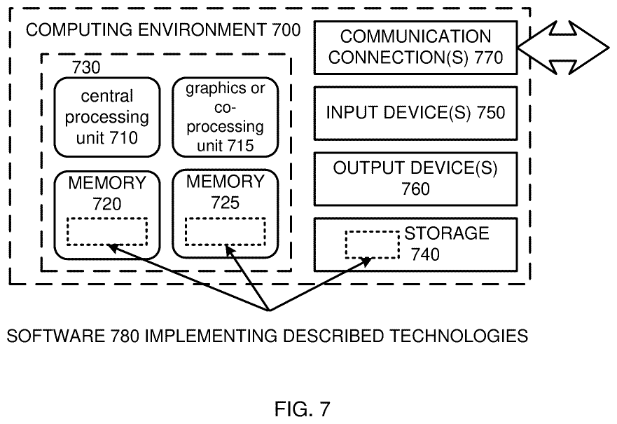

FIG. 7 depicts a generalized example of a suitable computing system 700 in which the described innovations may be implemented. The computing system 700 is not intended to suggest any limitation as to scope of use or functionality of the present disclosure, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions, such as for implementing the features described in Examples 1-8. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s) 710, 715. The memory 720, 725 stores software 780 implementing one or more innovations described herein, in the form of computer-executable instructions suitable for execution by the processing unit(s) 710, 715.

A computing system 700 may have additional features. For example, the computing system 700 includes storage 740, one or more input devices 750, one or more output devices 760, and one or more communication connections 770, including input devices, output devices, and communication connections for interacting with a user. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information in a non-transitory way, and which can be accessed within the computing system 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 10—Cloud Computing Environment

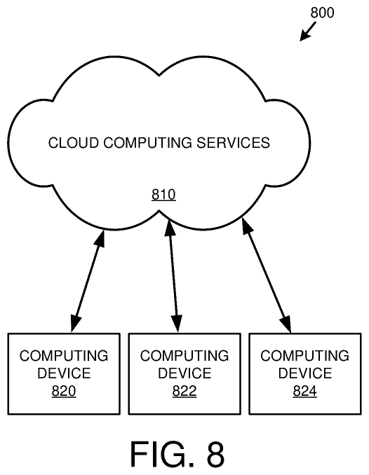

FIG. 8 depicts an example cloud computing environment 800 in which the described technologies can be implemented. The cloud computing environment 800 comprises cloud computing services 810. The cloud computing services 810 can comprise various types of cloud computing resources, such as computer servers, data storage repositories, networking resources, etc. The cloud computing services 810 can be centrally located (e.g., provided by a data center of a business or organization) or distributed (e.g., provided by various computing resources located at different locations, such as different data centers and/or located in different cities or countries).

The cloud computing services 810 are utilized by various types of computing devices (e.g., client computing devices), such as computing devices 820, 822, and 824. For example, the computing devices (e.g., 820, 822, and 824) can be computers (e.g., desktop or laptop computers), mobile devices (e.g., tablet computers or smart phones), or other types of computing devices. For example, the computing devices (e.g., 820, 822, and 824) can utilize the cloud computing services 810 to perform computing operations (e.g., data processing, data storage, and the like).

### Example 11—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 7, computer-readable storage media include memory 720 and 725, and storage 740. The term computer-readable storage media does not include signals and carrier waves. In addition, the term computer-readable storage media does not include communication connections (e.g., 770).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network, or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
at least one hardware processor coupled to the at least one memory; and
one or more computer readable storage media storing computer-executable instructions, that when executed, cause the computing system to perform routing operations for natural language generator models that reduce computing resource use for certain queries without a significant decrease in query response quality, the operations comprising:
receiving a first query;
generating for the first query a first set of one or more query difficulty metric values for a set of one or more query difficulty metrics;
determining, based on the first set of one or more query difficulty metric values, that the first query is of a first query difficulty level;
based on the determining that the first query is of the first query difficulty level, routing the first query to a first natural language generator model specified for the first query difficulty level;
receiving a second query;
generating for the second query a second set of one or more query difficulty metric values for the set of one or more query difficulty metrics;
determining, based on the second set of one or more query difficulty metric values, that the second query is of a second query difficulty level, the second query difficulty level being different than the first query difficulty level; and
based on the determining that the second query is of the second query difficulty level, routing the second query to a second natural language generator model specified for the second query difficulty level.

2. The computing system of claim 1, the operations further comprising:
generating a vector-space embedding of the first query;
submitting the vector-space embedding to a machine learning model to provide at least one query difficulty metric value of the one or more query difficulty metrics for the first query.

3. The computing system of claim 1, wherein a query difficulty metric of the one or more query difficulty metrics corresponds to a probability of an evaluated query having the first query difficulty level.

4. The computing system of claim 3, wherein the determining, based on the first set of one or more query difficulty metric values, that the first query is of a first query difficulty level, comprises comparing the probability to a threshold probability, and the first query is routed to the first natural language generator model based on determining that the probability satisfies the threshold probability.

5. The computing system of claim 1, the operations further comprising:
training a router that performs routing of received queries, including the first query and the second query, the training comprising:
for given queries of a set of training queries:
generating a vector-space embedding of a given query of the set of training queries;
generating a first response for the given query using the first natural language generator model;
generating a second response for the given query using the second natural language generator model;
calculating a quality metric for the first response;
calculating a quality metric for the second response;
assigning a label to a given query of the set of training queries using the quality metric for the first response and the quality metric for the second response, the label indicating whether the given query has the first difficulty level or the second difficulty level; and
generating a query difficulty metric value by submitting the vector-space embedding of the given query and the label for the given query to a machine learning model; and
minimizing a loss function that uses the label for the given query and the query difficulty metric value for the given query.

6. The computing system of claim 1, the operations further comprising:
training a router that performs routing of received queries, including the first query and the second query, the training comprising:
for given queries of a set of training queries:
generating a vector-space embedding of a given query of the set of training queries;
generating a first response for the given query using the first natural language generator model;
generating a second response for the given query using the second natural language generator model;
calculating a quality metric for the first response;
calculating a quality metric for the second response;
assigning a label to the given query of the set of training queries using the quality metric for the first response and the quality metric for the second response, the label indicating a probability of the quality metric for the first response being at least as high as the quality metric for the second response; and
generating a query difficulty metric value by submitting the vector-space embedding of the given query and the label for the given query to a machine learning model;
minimizing a loss function that uses the label for the given query and the query difficulty metric value for the given query.

7. The computing system of claim 1, the operations further comprising:
training a router that performs routing of received queries, including the first query and the second query, the training comprising:
for given queries of a set of training queries:
generating a vector-space embedding of a given query of the set of training queries;
generating a first response for the given query using the first natural language generator model;
generating a second response for the given query using the second natural language generator model;
calculating a quality metric for the first response;
calculating a quality metric for the second response;
assigning a label to the given query of the set of training queries using the quality metric for the first response and the quality metric for the second response, the label indicating a probability of the quality metric for the first response being higher than the quality metric for the second response minus an adjustment value; and
generating a query difficulty metric value by submitting the vector-space embedding of the given query and the label for the given query to a machine learning model; and
training the machine learning model by minimizing a loss function that uses the label for the given query and the query difficulty metric value for the given query.

8. The computing system of claim 1, the operations further comprising:
training a router that performs routing of received queries, including the first query and the second query, the training comprising:
for given queries of a set of training queries:
generating a vector-space embedding of a given query of the set of training queries;
generating a first response for the given query using the first natural language generator model;
generating a second response for the given query using the second natural language generator model;
calculating a quality metric for the first response;
calculating a quality metric for the second response;
assigning a label to the given query of the set of training queries using the quality metric for the first response and the quality metric for the second response, the label indicating a difficulty of the given query;
generating a query difficulty metric value by submitting the vector-space embedding of the given query and the label for the given query to a machine learning model;
training the machine learning model by minimizing a loss function that uses the label for the given query and the query difficulty metric value for the given query.

9. The computing system of claim 8, wherein calculating the quality metric for the first response is performed by a third natural language generator model, wherein the third natural language generator model is the first natural language generator model, the second natural language generator model, or is a natural language generator model other than the first natural language generator model and the second natural language generator model.

10. The computing system of claim 9, the operations further comprising:
submitting the first response to the third natural language generator model with instructions on how the quality metrics for the query responses are to be calculated.

11. The computing system of claim 1, the operations further comprising:
training a router that performs routing of received queries, including the first query and the second query, the training comprising:
for given queries of a set of training queries:
assigning a label to a given query of the set of training queries, the label indicating whether the given query has a first difficulty level or a second difficulty level;
generating a vector-space embedding of a given query of the set of training queries;
generating a first response for the given query using the first natural language generator model;
generating a second response for the given query using the second natural language generator model;
calculating a quality metric for the first response;
calculating a quality metric for the second response;
generating a query difficulty metric value by submitting the vector-space embedding of the given query and the label for the given query to a machine learning model; and
minimizing a loss function that uses the label for the given query and the query difficulty metric value for the given query.

12. The computing system of claim 11, the operations further comprising:
receiving user input assigning the label to the given query.

13. A method, implemented in a computing system comprising at least one hardware processor and at least one memory coupled to the at least one hardware processor, the method comprising:
training a router that performs routing of received queries to a determined natural language generator model of a plurality of available natural language generator models, the training comprising:
for given queries of a set of training queries:
generating a vector-space embedding of a given query of the set of training queries;
generating a first response for the given query using a first natural language generator model of the plurality of available natural language generator models;
generating a second response for the given query using a second natural language generator model of the plurality of available natural language generator models;
calculating a quality metric for the first response;
calculating a quality metric for the second response;
assigning a label to the given query using the quality metric for the first response and the quality metric for the second response, the label indicating a difficulty of the given query;
generating a query difficulty metric value by submitting the vector-space embedding of the given query and the label for the given query to a machine learning model; and
training the machine learning model to provide a trained machine learning model by minimizing a loss function that uses the label for the given query and the query difficulty metric value for the given query;
wherein the router comprises the trained machine learning model and selectively routes less difficult queries to the first natural language generator model, saving computing resources compared with processing the less difficult queries using the second natural language generator model.

14. The method of claim 13, further comprising:
generating at least a portion of the set of training queries using a third natural language generator model.

15. The method of claim 13, wherein calculating the quality metric for the first response is performed by a third natural language generator model, wherein the third natural language generator model is the first natural language generator model, the second natural language generator model, or is a natural language generator model other than the first natural language generator model and the second natural language generator model.

16. The method of claim 15, the operations further comprising:
submitting the first response to the third natural language generator model with instructions on how the quality metrics for the query responses are to be calculated.

17. The method of claim 13, wherein the label assigned to the given query indicates that the given query has a first difficulty level or a second difficulty level.

18. The method of claim 13, wherein the label indicates a probability of the quality metric for the first response being at least as high as the quality metric for the second response.

19. The method of claim 13, wherein the label indicates a probability of the quality metric for the first response being higher than the quality metric for the second response minus an adjustment value.

20. One or more computer-readable storage media comprising computer-executable instructions that cause a computing system to perform routing operations for natural language generator models that reduce computing resource use for certain queries without a significant decrease in query response quality, the one or more computer-readable storage media comprising:
computer-executable instructions that, when executed by a computing system comprising at least one hardware processor and at least one memory coupled to the at least one hardware processor, cause the computing system to receive a first query;
computer-executable instructions that, when executed by the computing system, cause the computing system to generate for the first query a first set of one or more query difficulty metric values for a set of one or more query difficulty metrics;
computer-executable instructions that, when executed by the computing system, cause the computing system to determine, based on the first set of one or more query difficulty metric values, that the first query is of a first query difficulty level;
computer-executable instructions that, when executed by the computing system, cause the computing system to, based on the determining that the first query is of the first query difficulty level, route the first query to a first natural language generator model specified for the first query difficulty level;
computer-executable instructions that, when executed by the computing system, cause the computing system to receive a second query;
computer-executable instructions that, when executed by the computing system, cause the computing system to generate for the second query a second set of one or more query difficult metric values for the set of one or more query difficulty metrics;
computer-executable instructions that, when executed by the computing system, cause the computing system to determine, based on the second set of one or more query difficulty metric values, that the second query is of a second query difficulty level, the second query difficulty level being different than the first query difficulty level; and
computer-executable instructions that, when executed by the computing system, cause the computing system to, based on the determining that the second query is of the second query difficulty level, route the second query to a second natural language generator model specified for the second query difficulty level.
